(19) United States
(12) Patent Application Publication
(10) Pub. No.: US 2014/0209765 A1
(43) Pub. Date: Jul. 31, 2014

(54) Cable Tidy

(71) Applicant: Perry Coppen, Kent (GB)

(72) Inventor: Perry Coppen, Kent (GB)

(21) Appl. No.: 13/750,809

(22) Filed: Jan. 25, 2013

(51) Int. Cl. F16L 3/137; F16L 3/22

(52) U.S. Cl. CPC F16L 3/137; F16L 3/22
USPC 248/74.3

(57) ABSTRACT

A cable tidy comprises a flexible elongate backing strip having an adhesive layer adapted to attach the cable tidy to a surface, and has means to form an elongate channel adapted to house at least one cable, the channel running along the longitudinal axis of the cable tidy. The cable tidy may be cut to different lengths, may affix to objects such that it runs around corners and can be provided in a roll.

### BACKGROUND OF THE INVENTION

1. Field of the Invention

This application claims priority to United Kingdom application number GB1201260.5 filed on Jan. 25, 2012, and is incorporated herein in its entirety by reference. The present invention relates to a cable tidy.

2. Prior Art

Cable tidies are used in many situations, including domestic, office and industrial in order to neatly and safely store a cable. In particular, on building sites many cables are required for powering equipment and the like, and often only temporarily during the time of construction. With the amount of foot traffic and transportation of heavy machinery conventionally seen throughout a building site, there is a need to temporarily store and secure cables out of the way of door ways, walk ways, and other trafficked areas so as no one trips on them, or possibly damages the cable. Currently, on many building sites, workers will often use very quick and cost effective methods for accomplishing this, for example either by duct taping the cables to a wall or hanging them from one or more nails. However, both of these techniques are relatively simple solutions to the problem and conventionally have additional problems associated with them.

Duct taping a cable to the wall is an easy temporary way of securing a cable to a wall and out of foot trafficked areas. However, to add an additional cable to an existing duct tape arrangement one must obtain more duct tape and fasten the extra cable to the wall, which is a time consuming process. In addition, use of duct tape for this purpose results in further waste materials.

Further, hanging cables from nails that have been hammered into a wall is a common practice to raise cables above the ground. However, the use of nails poses at least two main problems. Cables that are hanging on a nail are not fastened to anything. Thus such cables can be inadvertently and easily dislodged, even by a strong wind. Also, nails hammered into a wall need to eventually be removed, with the resultant hole taking time and money to fill in.

Still further, some existing cable tidies that attempt to address these issues comprises closures adjacent to their edges, which can make such tidies difficult to open and close when, for example, wearing gloves.

As such, there is a continuing and unmet need for a cable tidy device which seeks to address these and other issues.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art the provision of a cable tidy comprising:

a flexible elongate backing strip having at least one adhesive area adapted to attach the cable tidy to a surface, the longitudinal axis of the elongate backing strip defining the longitudinal axis of the cable tidy;

a flexible elongate covering strip having first and second edges running parallel to the longitudinal axis of the cable tidy;

wherein the covering strip comprises means for releasably attaching to the backing strip running substantially parallel to the longitudinal axis of the cable tidy and at a point between the first and second edges of the covering strip so as to define an elongated channel on the backing strip and at least one tab adjacent the second edge of the covering strip; and

wherein the channel is adapted to house at least one cable, and runs along the longitudinal axis of the cable tidy.

In accordance with at least one preferred mode, the cable tidy is substantially flexible and elongated which provides many advantages as it is readily employable over any terrain, for example around corners, and may be readily cut to a size appropriate for its use. The flexibility also allows for it to be provided in a roll.

Further, in one mode it is particularly advantageous to provide at least one release tab engaged to the covering strip which allows the user to grasp the covering strip of the cable tidy so as to open and close the channels as needed for the addition or removal of an operatively engaged cable.

It is additionally preferred that the means for releasably attaching the covering strip to the backing strip extends continuously along the longitudinal axis of the cable tidy. In one mode the means for releasably attaching to the backing strip is located at a point between the first and second edges of the covering strip so as to define a single tab adjacent the second edge of the covering strip, the second edge being the free edge. The provision of a single continuous tab at the free edge of the cable tidy means that no matter what length the cable tidy is cut to, there will always be a release tab available to assist in opening and closing access to the channel.

In another mode the means for releasably attaching the covering strip to the backing strip is located at a point between the first and second edges of the covering strip so as to define a plurality of tabs adjacent the second edge of the covering strip. The provision of a plurality of tabs along the free edge of the covering strip of the cable tidy reduces the amount of material needed to construct the cable tidy, therefor reducing manufacturing costs.

In yet another mode the means for releasably attaching the covering strip to the backing strip, is spaced from a free edge of the backing strip. By spacing the means for releasably attaching the covering strip to the backing strip from a free edge of the backing strip, adhesive areas to either side of the attachment area are provided. This reduces the chances of accidentally pulling the cable tidy from a surface when detaching the covering strip from the backing strip.

In still another preferred mode, the flexible elongated covering strip is formed in as a unitary piece with the backing strip such that the point where the covering strip joins the backing strip defines the first edge of the covering strip.

In still yet another particularly preferred mode the flexible elongated covering strip is formed separately and is removably engageable to the backing strip along or adjacent to its first edge.

In accordance with at least one mode, preferably the means for releasably attaching the covering strip to the backing strip is hook and loop fastener. However, other means for releasably attaching which are deemed suitable by those skilled in the art may be employed and are anticipated, for example, snap fits, magnets, clips, or other suitable fastener known in the art.

In accordance with at least one mode, preferably the covering strip and the backing strip comprise corresponding elongate areas of hook and loop fastener extending along the longitudinal axis of the cable tidy.

The various components of the device herein can be formed of conventional materials such as textile materials or plastics, however can be formed from any material deemed suitable by those skilled in the art.

In accordance with at least one preferred mode, the cable tidy is in the form of a roll.

In accordance with at least one preferred mode the cable tidy comprises a protective layer that may be peeled from the cable tidy so as to reveal the adhesive layer on the backing strip.

In accordance with at least one preferred mode, preferably the elongate channel is adapted to house a plurality of cables.

It is briefly noted that upon a reading this disclosure, those skilled in the art will recognize various means for carrying out these intended features of the invention. As such it is to be understood that other devices may be configured to carry out these features and are therefor considered to be within the scope and intent of the present invention, and are anticipated.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments, modes and/or features. It is intended that the embodiments and figures disclosed herein are to be considered illustrative rather than limiting. In the drawings:

FIG. 1 shows a schematic cross-section of a cable tidy made in accordance with a first preferred mode of the present invention.

FIG. 2 shows a front view of part of the cable tidy of FIG. 1.

FIG. 3 shows segments of cable tidy made in accordance with the present invention holding up a cable on a wall.

FIG. 4 shows a segment of a cable tidy made in accordance with the present invention holding up a cable over a door.

FIG. 5 shows a cable tidy made in accordance with a second preferred mode of the present invention.

FIG. 6 shows a cable tidy made in accordance with a third preferred mode of the present invention.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

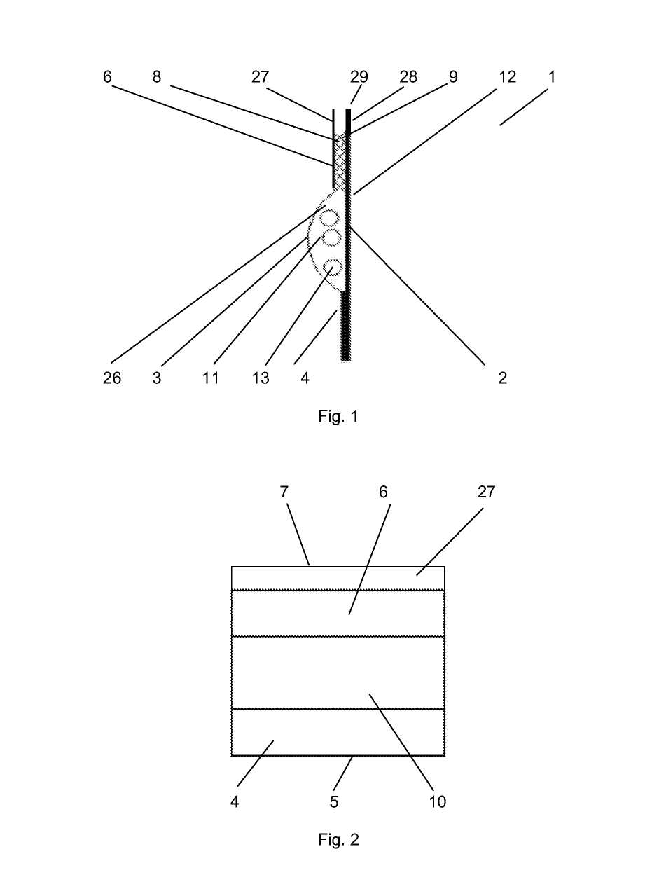

Referring to the drawings in FIGS. 1-6, FIG. 1 shows an elongated cable tidy 1, having a backing layer 2 and a covering layer 3. The backing layer 2 and covering layer 3 are both preferably elongated, of the same lengths, and of approximately the same width when in use, although the covering layer 3 may be slightly wider in order that a cable-containing channel may be formed between the covering layer 3 and backing layer 2. However it is noted and anticipated that those skilled in the art may envision various modifications to the preferred modes described herein, and while accomplishing the intended features and advantages of the present invention are considered part of this disclosure.

With that being said, it is preferred that both the backing layer 2 and covering layer 3 are formed of a textile material and cable tidy 1 is therefore very flexible. However other materials deemed suitable by one skilled in the art may be employed, and are anticipated.

In the current mode, the covering layer 3 is preferably permanently engaged to the backing layer 2 along an attachment area 4 which runs in the form of a continuous strip along the longitudinal axis of the cable tidy adjacent to a first edge 5 of the covering layer 3 of the cable tidy. The covering layer 3 and backing layer 2 may be permanently attached to each other by any suitable means for permanent engagement. For example adhesive or stitching.

The covering layer 3 is preferably releasably attachable to the backing layer 2 along an attachment area 6 which runs in the form of a continuous strip along the longitudinal axis of the cable tidy between a first edge 5 and a second edge 7 of the covering layer 3 of the cable tidy.

Means for releasably attachment of the covering layer 3 to the backing layer 2 is preferably provided by means of hook and loop fasteners 8, 9 located at the attachment area 6. In the present preferred mode the covering layer 3 comprises hook fastener 8 and backing layer comprises loop fastening 9, but it will of course be recognized that this could be reversed. Further, it is noted and anticipated that other means for releasably attaching may be employed and are anticipated, for example, snap fits, magnets, clips, or other suitable fastener known in the art.

When the covering layer 3 is attached to the backing layer 2 by means of hook and loop fasteners 8, 9 at the attachment area 4, a central section 10 and the backing layer 2 form an elongated channel 11, defining an as-used mode of the invention, as clearly shown in the drawings.

Furthermore, the attachment area 6 is preferably not adjacent to the edge 7, such that when the covering layer 3 is attached to the backing layer 2 at the attachment area 6, not only is the elongated channel 11 defined between the covering layer 3 and the backing layer 2, but release tab 27 is also provided. Thus, the attachment area 6 is spaced from the free edge 7 of the covering layer 3 along at least part of the length of cable tidy 1.

The release tab 27 is of particular importance when the cable tidy 1 is deployed in environments where the wearing of gloves, is commonplace or even mandatory. The release tab 27 is intended to be easily grasped between a users thumb and forefinger and further allows for users wearing gloves to readily detach and reattach the covering layer 3 to the backing layer 2 at attachment area 6.

The backing layer 2 is coated or otherwise formed with an adhesive (not shown) on its rear side 12. This adhesive layer allows for cable tidy 1 to be engaged to any desired surface.

The backing layer 2 is further adapted to form the channel 11 on its front side 26, which faces outwards from a surface to which cable tidy 1 is attached (by means of the adhesive rear side 12) when cable tidy 1 is in use.

As can be seen from FIG. 1, in some preferred modes the attachment area 6 may also be located such that hook or loop fasteners 9 are spaced from longitudinal edge 29 of backing layer to so as to provide an adhesive backing attachment area 28 adjacent to longitudinal edge 29 of the backing layer 2. Thus, attachment area 6 is spaced from the free edge 29 of backing layer 2 along at least part of the length of cable tidy 1 to provide means for preventing accidental grasping of the edge 29 and inadvertent removal of the backing layer 2.

In the present preferred mode the adhesive backing attachment area 28 reduces the possibility of cable tidy 1 becoming accidentally removed from a surface when a user is detaching the hook and loop fasteners 8, 9 at the attachment area 6 by pulling on the tab 27. This feature is especially preferred when the user is wearing bulky gloves, and where otherwise the glove may catch the edge 29 and accidentally remove the backing layer 2.

However, in another particularly preferred modes, the area 28 may in fact not be an attachment area, but could instead be free of adhesive on its surface such that it may act as a tab configured to facilitate peeling off of the backing layer 2 thereby enabling a user with means for removing the cable tidy from a surface once its use is no longer required.

Whether or not the area 28 comprises an adhesive so as to adhere area 28 to a surface, its presence is advantageous as it provides the user with a surface to exert counteracting pressure to, so as to assist when pulling on tab 27 to release hook and loop fastenings 8, 9 while keeping the backing layer 2 attached to the surface due to the counteracting pressure the user exerts.

In accordance with at least one preferred mode, the cable tidy 1 may be provided in strips, and advantageously, owing to the flexibility of the materials it is constructed from may be provided in the form of a roll.

In use a user is provided with the whole or part of cable tidy 1, either in an appropriate length, or if, for example, the cable tidy is provided in the form of a roll the user may cut off the length that they require. This is owing to the cable tidy being constructed from flexible materials and therefore severable with a standard pair of scissors or knife.

Once the user has obtained the length of cable tidy appropriate for the task in hand they may peel off a protective layer (not shown) that covers the adhesive layer on backing layer 2. Thus the adhesive layer is revealed and cable tidy 1 may be attached to the surface that the user wishes to run cables along.

Once attached to the surface, for example a wall or floor, the user may (if not already open) access the channel 11 by partly detaching the covering layer 3 from backing layer 3 by disengaging the hook and loop fasteners 8, 9 by pulling on tab 27. Cables 13 may then be positioned in between the covering layer 3 and the backing layer 2 such that they communicate within the channel 11 with their longitudinal axes running along the longitudinal axis of channel 11 (which is also the longitudinal axis of cable tidy 1). It is noted that one or a plurality of cables 13 may be stored in the same channel 11.

Advantageously, if the user desires to add or remove a cable to a cable tidy 1 that has already been deployed, the user may readily open and close access to the channel 11 by employing the hook and loop fastener 8, 9 by grasping tab 27. This access may be gained repeatedly, and as many times as necessary.

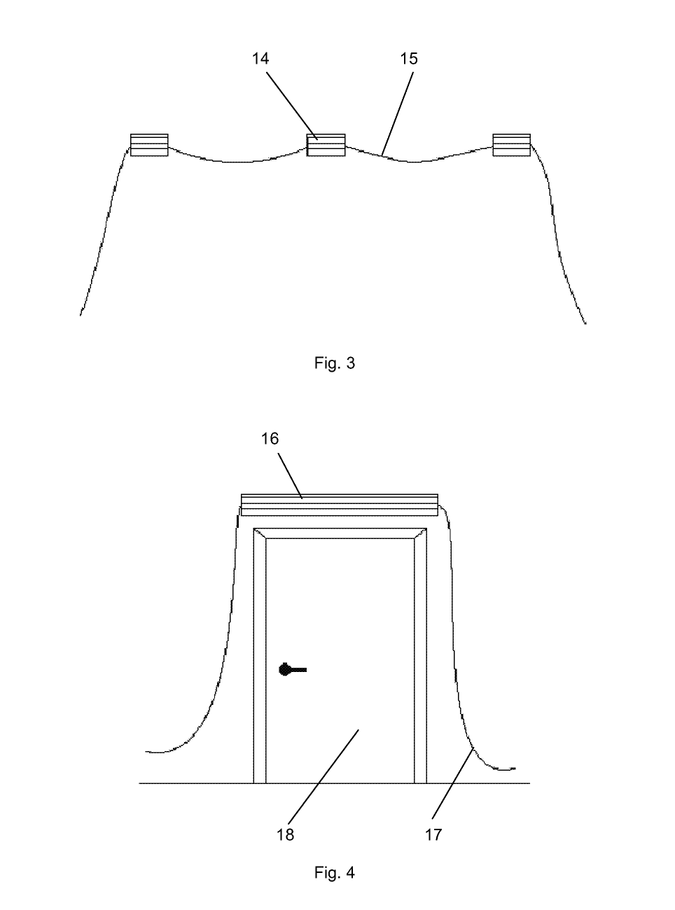

Turning now to FIGS. 3 and 4 there are seen example deployments of the as-used mode of lengths of cable tidy made in accordance with the present invention in use. As can been seen from FIG. 3, short lengths of the cable tidy 14 may be cut from a longer roll of the cable tidy and positioned on a wall so as to secure one or more cables 15 to a wall at intervals.

FIG. 4 shows a second deployed as-used mode for a length of cable tidy 16. As can be seen a length of the cable tidy may be used so as to ensure that a cable 17 passing over a door 18 does not hang down so as to interfere with the doorway.

This invention has other applications, potentially, and one skilled in the art could discover these. The explication of the features of this invention does not limit the claims of this application; other applications developed by those skilled in the art will be included in this invention. For example, the cable tidy may be run along floors as well as walls so as to mitigate tripping hazards and protect the cable from damage such as abrasion. Owing to the very flexible nature of the material of the cable tidy it may readily bend around corners and bends.

Indeed the flexible nature of the cable tidy of the present invention is particularly advantageous allowing for a plurality of cables to be rapidly and neatly tided, and held in a fixed position around and over various obstacles, for example up staircases.

The cable tidy may be provided to users, without implying limitations, either in strips, for example in lengths of any of 10 cm or more, 20 cm or more, 50 cm or more, 1 m or more, or on rolls of 1 m or more, 2 m or more, 5 m or more, etc.

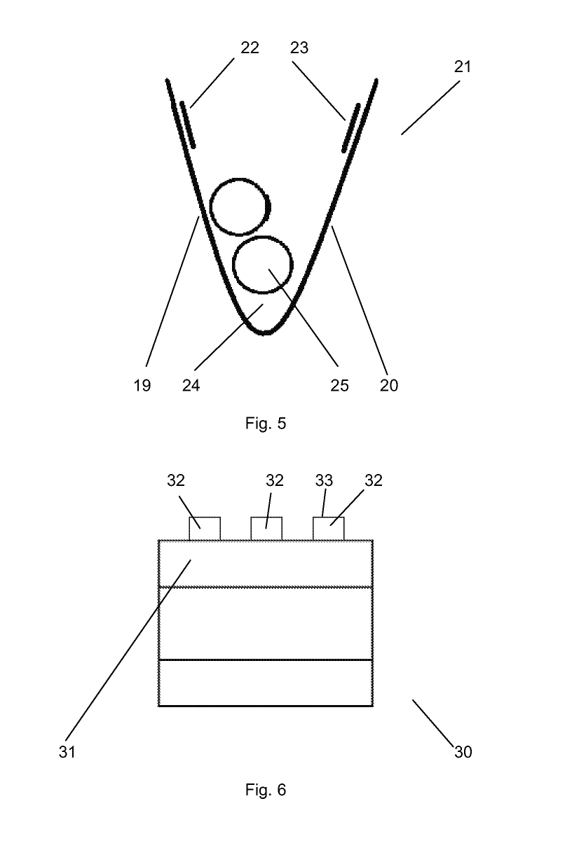

Turning to a second preferred mode of the present invention and referring to FIG. 5, in contrast to the preferred mode of FIG. 1, the covering layer 19 and backing layer 20 of the cable tidy 21 are formed in a unitary piece such that the backing layer 20 simply loops around so as to act as the covering layer 19.

In most other respects the cable tidy 21 is the same as that in the previously disclosed preferred modes. The backing layer 20 still comprises an adhesive layer (not shown) so as to attach the cable tidy to a surface. The covering layer 19 and backing layer 20 still preferably comprise corresponding hook and loop fastenings 22, 23 so as to attach the covering layer to the backing layer and form an elongate channel 24 adapted to house one or more cables along the longitudinal axis of the cable tidy 21. FIG. 5 shows the cable tidy 21 in an open position allowing a user to access the channel 24. It is readily apparent that to seal access to channel 24, the hook and loop fasteners 22, 23 may simply be attached together.

Turning now to FIG. 6, and third preferred mode of the present invention is shown. It is noted that in some instances it may be preferable to employ a plurality of tabs 32 adjacent the free edge 33 of the covering strip instead of a single tab (numbered 27 in FIG. 1). Such an arrangement results in a reduced amount of material being used, but still allows for users wearing gloves to readily open and close the cable tidy.

It is noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular preferred modes thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

1. A cable tidy comprising:
a flexible elongate backing strip having at least one adhesive area adapted to attach the cable tidy to a surface, the longitudinal axis of the elongate backing strip defining the longitudinal axis of the cable tidy;
a flexible elongate covering strip having first and second edges running parallel to the longitudinal axis of the cable tidy;
wherein the covering strip comprises means to releasably attach to the backing strip running substantially parallel to the longitudinal axis of the cable tidy and at a point between the first and second edges of the covering strip so as to define an elongate channel on the backing strip and at least one tab adjacent the second edge of the covering strip;
and wherein the channel is adapted to house at least one cable, and runs along the longitudinal axis of the cable tidy.

2. The cable tidy of claim 1 wherein the means to releasably attach the covering strip to the backing strip runs continuously along the longitudinal axis of the cable tidy.

3. The cable tidy of claim 1 wherein the means to releasably attach to the backing strip is located at a point between the first and second edges of the covering strip so as to define a single tab adjacent the second edge of the covering strip.

4. The cable tidy of claim 1 wherein the means to releasably attach the covering strip to the backing strip is located at a point between the first and second edges of the covering strip so as to define a plurality of tabs adjacent the second edge of the covering strip.

5. The cable tidy of claim 1 wherein the means to releasably attach the covering strip to the backing strip is spaced from a free edge of the backing strip.

6. The cable tidy of claim 1 wherein the flexible elongate covering strip is formed in one piece with the backing strip such that the point where the covering strip joins the backing strip defines the first edge of the covering strip.

7. The cable tidy of claim 1 wherein the flexible elongate covering strip is formed separately and attached to the backing strip along or adjacent to its first edge.

8. The cable tidy of claim 1 wherein the means to releasably attach the covering strip to the backing strip is hook and loop fastening.

9. The cable tidy of claim 8 wherein the covering strip and the backing strip comprise corresponding elongate areas of hook and loop fastening running along the longitudinal axis of the cable tidy.

10. The cable tidy of claim 1 wherein the backing strip is formed of a textile material.

11. The cable tidy of claim 1 wherein the covering strip is formed of a textile material.

12. The cable tidy of claim 1 wherein the cable tidy is in the form of a roll.

13. The cable tidy of claim 1 comprising a protective layer that may be peeled from the cable tidy so as to reveal the adhesive layer on the backing strip.

14. The cable tidy of claim 1 wherein the channel is adapted to house a plurality of cables.
